(19) United States
(12) Patent Application Publication
(10) Pub. No.: US 2004/0195818 A1
(43) Pub. Date: Oct. 7, 2004

(54) Apparatus to enhance automobile suspension travel, front roller bumper, reverse shackle application and a 2" or 4" suspension lift.

(76) Inventors: Frank A. Borke, (US); George C. Stickles, (US)

Correspondence Address: George C. Stickles, 13380 Harrison Street, Thornton, CO, 80241, US

(21) Appl. No.: 10/406,540

(22) Filed: Apr. 3, 2003

(51) Int. Cl. B60R 21/00

(52) U.S. Cl. 280/787

(57) ABSTRACT

The reverse shackle system is designed to reverse the OEM leaf spring mounting design by moving the stationary mount to the front of the leaf spring in the front suspension increasing steering and handling stability. The roller bumper is designed to enable ascending on boulders utilizing a steel tube shafted by another steel tube creating a front roller. The front mounting component for reverse shackle system and roller bumper is a one piece unit providing a ridgidness of the portion of the vehicle frame. The front and rear suspension drop-arm shackle mounts are a system to increase front and rear independent suspension drop or wheel articulation. The drop-arm shackle mount pivots and drops allowing increase independent wheel travel. The rear leaf spring mounting system allows for movement of rear axle rearward for large tire applications as well as increased independent drop and wheel travel. The mounting front and rear mounting system allows for a 2″ or 4″ suspension lift.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of automobiles and more specifically to an apparatus to reverse front shackle system of the Jeep Models CJ5, CJ6, CJ7, CJ8, YJ Wranglers and other front shackle leaf spring applications with an apparatus to promote wheel travel to leaf spring suspensions, front roller bumper and a 2″ or 4″ suspension lift.

The drop-arm reverse shackle system is a complete one piece system. The reverse shackle mount is a system that moves the stationary leaf spring mount to the front of the leaf springs enabling the spring to depress and lengthen rearward.

The design is engineered to move the front axle forward to compensate for the rearward movement of the axle when depressed thus allowing for large tire applications. The design is engineered as a one-piece unit that encases the frame decreasing side-to-side frame flex promoted by pressure on the frame from the steering box with large tire applications. This feature increases steering and handling stability.

The drop-arm shackle mount is a pivot arm in which the shackle is mounted to and then to the leaf spring. This system is engineered for the front and rear suspension. The pivot arms are designed with a locking mechanism utilizing a ⅜″ clevis pin. When not in locked position drop-arm will disengage allowing suspension and axle to independently drop providing more articulation or axle travel.

The front roller bumper is a 3″ urethane coated tube shafted by a 2″ steel tube. This bumper roller is designed to engage on an obstacle such as a boulder and with forward pressure to roll up on to obstacle allowing tires to grab. The front and rear mounting brackets are points of attachment for tow straps. The front roller bumper will be offered with or without the reverse shackle application.

The drop-mount shackle arm utilizes and elliptical eye and oversized bushing for maximum flex. The construction of the drop-mount shackle arm is a 1″ square tubing. The drop-mount shackle arms are pinned into place utilizing ⅜″ clevis pins for highway driving.

The normal shackle operation is then restored allowing for normal lengthening of the leaf springs under depression of normal driving.

### BRIEF SUMMARY OF THE INVENTION

The primary object of the invention is to provide additional suspension and axle travel beyond capabilities of leaf springs.

Another objective of the invention is to provide a front reverse shackle system utilizing a one piece reverse shackle mounting system.

Yet another object of the invention is to provide the ability to adjust the front axle forward for larger tire application.

Still yet another object of the invention is to provide a front roller bumper that enables vehicle to ascend over obstacles utilizing the roller bumper system.

Yet a further object of the invention is to provide a system to move rear axle rearward and adjustability of rear axle for large tire applications.

Still yet a further objective is to provide 2″ or 4″ suspension lift and tow strap attachment points.

Other objects and advantages of the present invention will. become apparent from the following descriptions, taken in connection with the accompanying drawings, wherein, by way of illustration and example, an embodiment of the present invention is disclosed.

In accordance with a preferred embodiment of the invention, there is disclosed an apparatus to reverse front shackle system of the Jeep Models CJ5, CJ6, CJ7, CJ8, YJ Wranglers and other front shackle leaf spring applications combining with an apparatus to promote wheel travel, front roller bumper, steering and handling capabilities and a 2″ or 4″ suspension lift comprising: a front suspension reverse shackle system, a roller bumper, a front suspension drop-arm shackle mount, a front suspension drop-arm shackle mount locking mechanism, front and rear bumper tow strap attachment points, a rear suspension drop-arm shackle mount, a rear suspension drop-arm shackle mount locking mechanism, an adjustable rear spring mount, an over-sized drop-mount bushing and a 2″ or 4″ suspension lift.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

Drawing 1 is a perspective view of Armadillo Rock Crawling Kit as assembled on automobile frame.

Drawing 2 perspective elevational view of front roller bumper.

FIG. 2.2 front perspective elevational view of stabilizing tube.

FIG. 2.5 front perspective elevational view of roller bumper.

Drawing 3 front elevational view of roller bumper.

FIG. 2.4 front elevational view of reverse shackle application.

Drawing 4 is a right side explosional view of roller bumber assembly.

FIG. 3.1 side elevational view of polyurethane coated roller bumper tubing.

FIG. 3.2 side elevational view of 3″ roller bumper tubing.

FIG. 3.3 side elevational view of 2″ roller bumper shaft.

FIG. 3.4 side elevational view of grease fitting assembly.

Drawing 5 is a perspective view of the rear frame to spring shackle mount of front reverse shackle system.

FIG. 4.1 side elevational view of drop arm shackle mount extended.

FIG. 4.2 side elevational view of spring shackle.

FIG. 4.3 side elevational view of polyurethane bushing.

FIG. 4.4 side elevational view of drop arm shackle mount in pinned street

Drawing 6 side elevational view of rear adjustable spring mount.

FIG. 5.1 side elevational view of adjustable spring mounting holes.

Drawing 7 side elevational view of rear spring shackle mount bumper assembly.

FIG. 6.1 side elevational view of 2″ stabilizing tube.

FIG. 6.2 side elevational view of drop mount arm.

FIG. 6.3 side elevational view of drop mount arm in pinned position.

FIG. 6.4 side elevational view of bumper mount.

Drawing 8 side elevational view of eliptical drop mount arm.

FIG. 7.1 side elevational view of eliptical drop mount arm.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The reverse shackle mount is an apparatus designed for the Jeep Models CJ5, CJ6, CJ7, CJ8, YJ Wrangler and other front shackle leaf spring applications. The reverse shackle mounts are made of ¼″ steel plating, CNC plasma cut and fully welded for maximum strength. The structure encases the outside of the frame preventing twisting of the steering box and frame due to increased pressure of large tires applications which promotes excellent steering and handling capabilities. This application increases ride height 2″ or 4″ by lifting suspension 2″ or 4″ utilizing front and rear mounting system.

The front roller bumper is an intricate part of the design, (Drawing 2, Drawing 3). The 3″ diameter polyurethane covered roller is designed to roll vehicle up those vertical rock inclines until the tires can grab and take over. The shaft is high strength 2″ tubing ¼″ wall thickness with another 7/16″ wall tube that is slid over the shaft to create a 24″ roller, (Drawing 4). The exterior tube is coated with a tough polyurethane coating and is provided with a grease fitting enabling to lubricate roller for a smooth operation. The roller is designed to remove and replace.

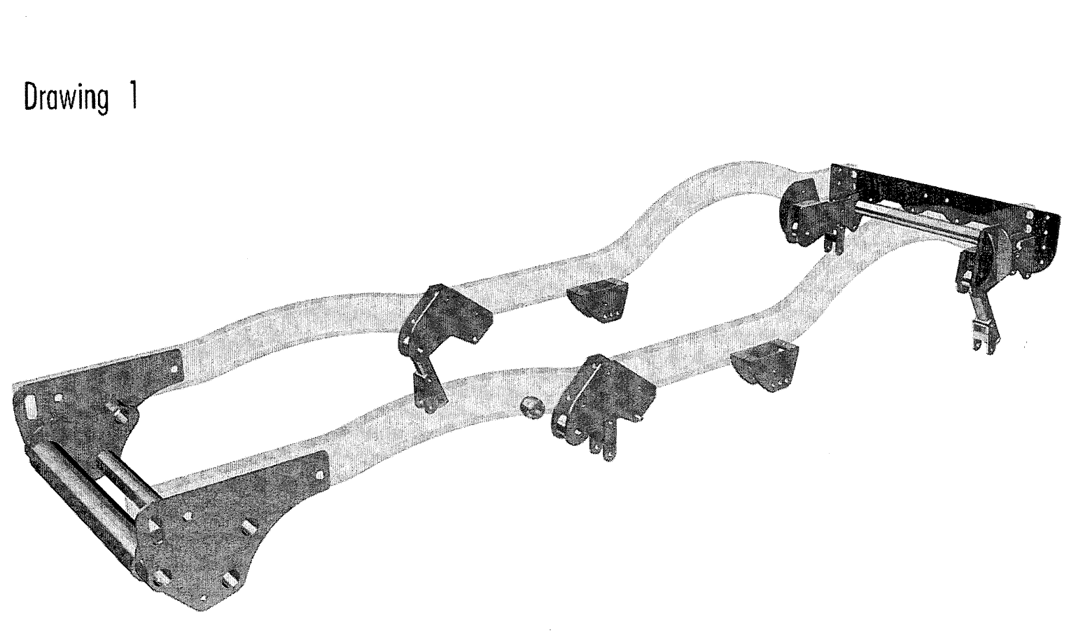

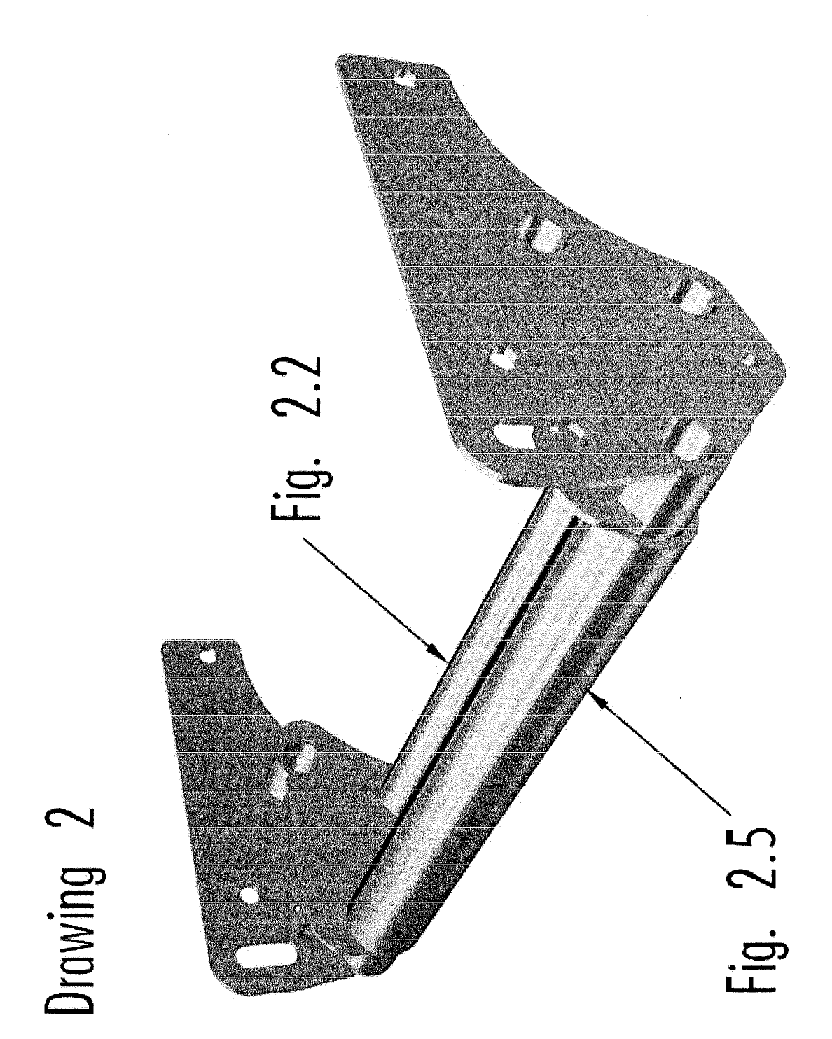

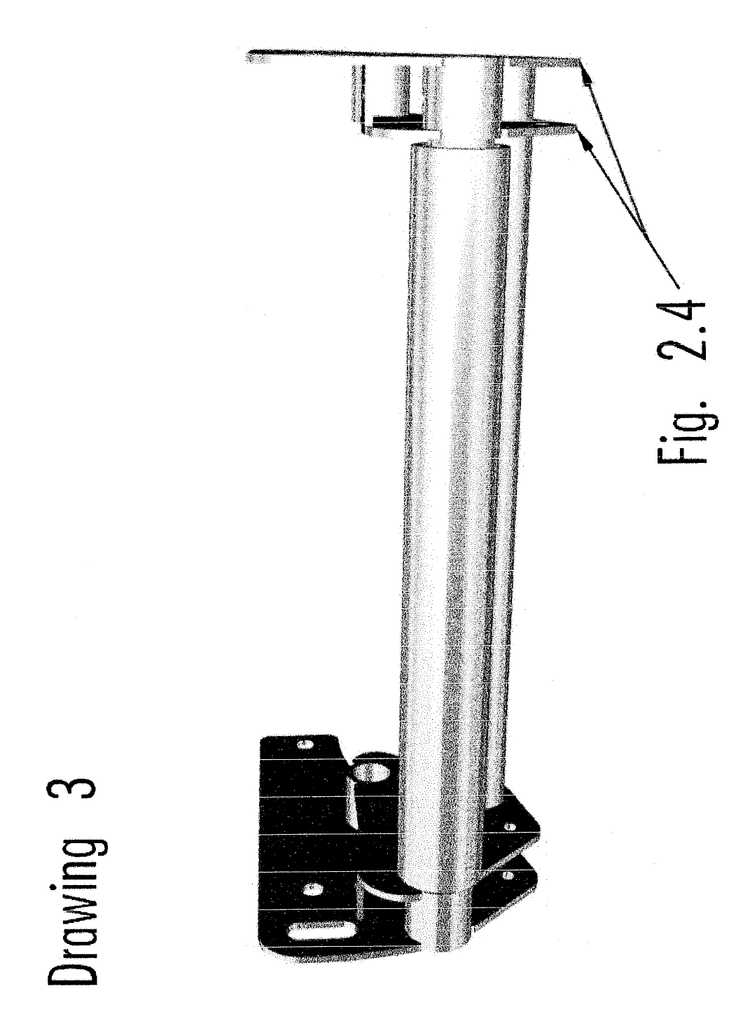

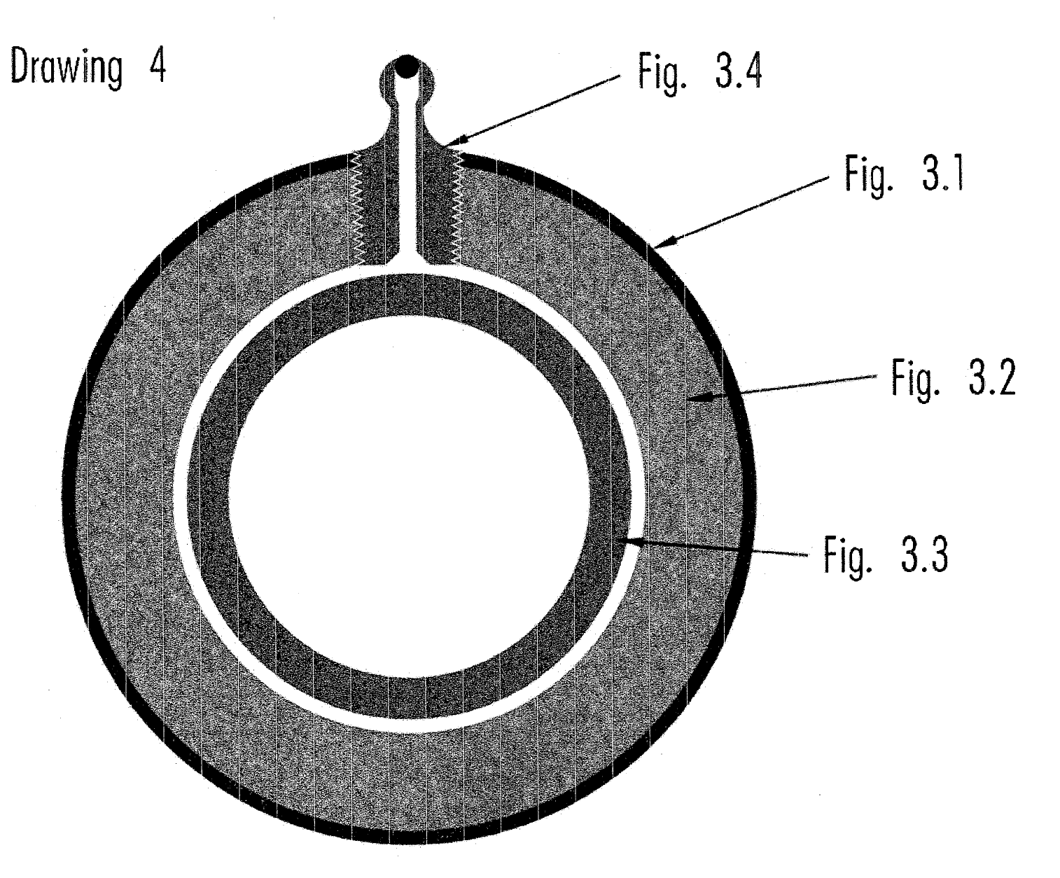

A heavy-duty 2″ stabilizing tube is welded solidly in place to stabilize main structure of the front reverse shackle mount and bumper, (Drawing 2, FIG. 2.2). The front bumper will be available with or without front reverse shackle application.

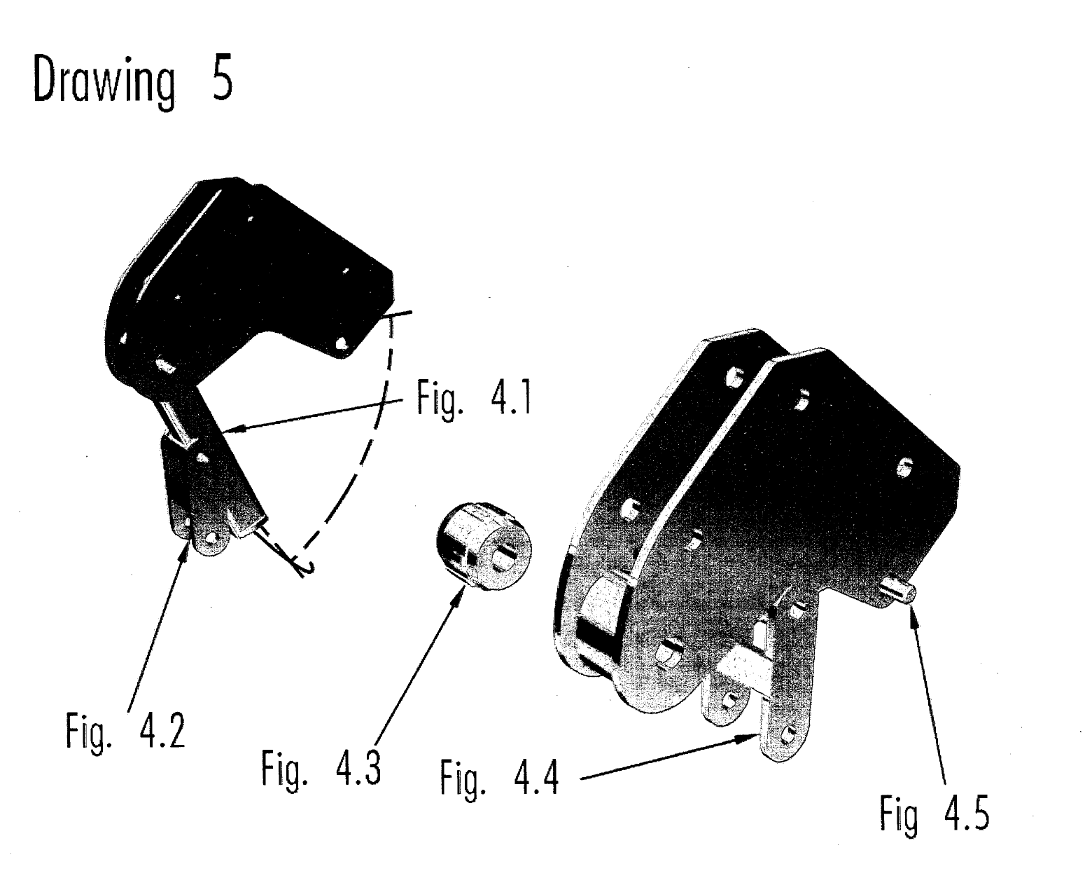

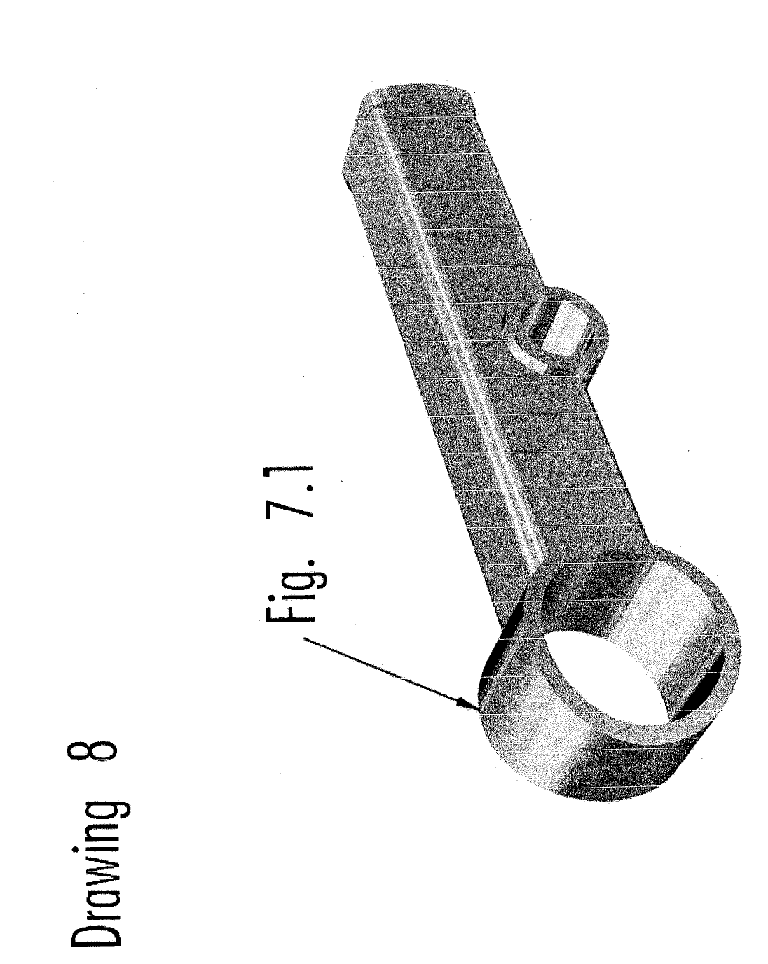

The rear spring shackle mounts of the front reverse shackle system is a unique design, (Drawing 5). The shackles attach to a drop-arm shackle mount, (Drawing 5, FIG. 4.1). In the pavement position the drop-arm shackle mount is pinned and stationary for road stability, (Drawing 5, FIG. 4.5). In the crawling position the pins are removed allowing the independent drop-arm shackle mount to float promoting an extraordinary wheel travel, (Drawing 5, FIG. 4.1). The drop-arms have a unique elliptical design, (Drawing 8, FIG. 7.1), with oversized urethane bushings, (Drawing 5, FIG. 4.3). This design allows for maximum articulation and flexibility with improved side-to-side stability. Heavy-duty ¼″ steel plating and engineering are key to this design.

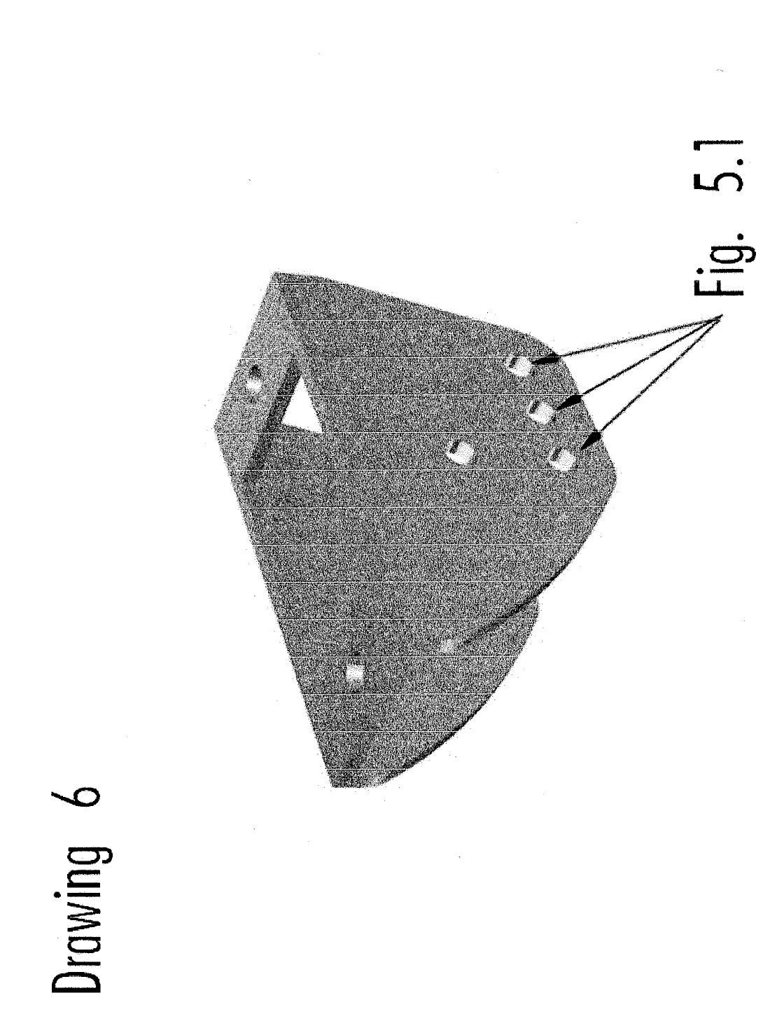

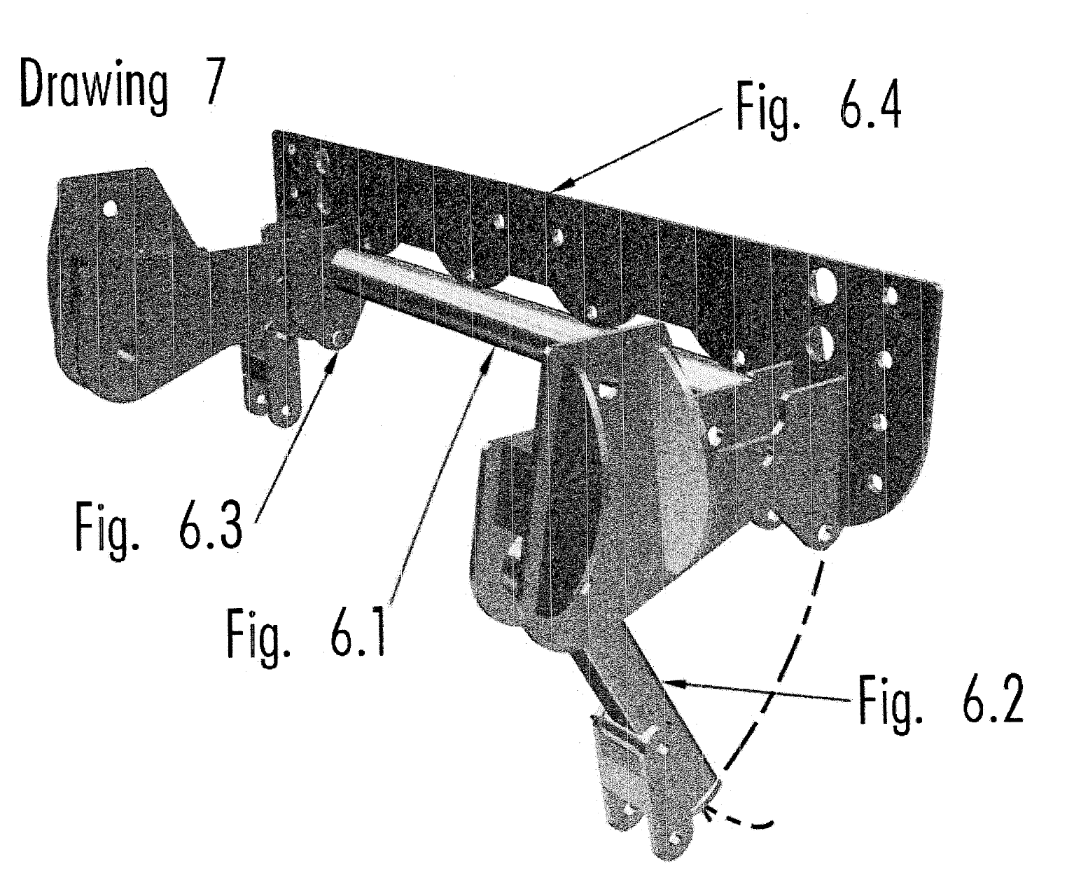

The rear spring shackle mount bumper assembly has the drop-arm shackle mount design as well, (Drawing 7). The front OEM shackle mounts are used as the attachment point for the new heavy-duty adjustable spring mount. This mount enables you to move your axle rearward ¾″ to 1½″ for larger tire applications, (Drawing 6, FIG. 5.1). The rear OEM shackle mounts are removed and replaced by the with the drop-arm shackle mount design, (Drawing 7, FIG. 6.2). The drop mount is pinned for pavement driving, when hitting the trail remove pins and let the independent drop-shackle mount kick into action and allow another 8″ of independent articulation, (Drawing 7, FIG. 6.3). The rear drop mounts are provided with the same unique elliptical design with an oversized urethane bushings to allow maximum flex in the extended position, (Drawing 8, FIG. 7.1, Drawing 5, FIG. 4.6).

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus to reverse front shackle system of the Jeep Models CJ5, CJ6, CJ7, CJ8, YJ Wranglers and other front shackle leaf spring applications combining with an apparatus to promote wheel travel, front roller bumper, steering and handling capabilities and a 2″ or 4″ suspension lift comprising:
a front suspension reverse shackle system;
a roller bumper;
a front suspension drop-arm shackle mounts;
a front suspension drop-arm shackle mount locking mechanisms;
front and rear bumper tow strap attachment points;
a rear suspension drop-arm shackle mounts;
a rear suspension drop-arm shackle mount locking mechanisms;
an adjustable rear spring mounts;
a over-sized drop-mount bushings;
a 2″ or 4″ suspension lift.

2. The invention of claim 1 is a one-piece front and rear mounting system.

3. The invention of claim 2 further compromising:
2″ or 4″ suspension lift.

4. The invention of claim 2 provides housing for roller bumper.

5. The invention of claim 1 is a pivoting drop-arm.

6. The invention of claim 5 provides a drop-arm locking mechanism.

7. The invention of claim 4 further compromising:
A shafted 3″ tube roller surfaced in a urethane coating.

8. The invention of claim 1 further compromising:
Adjustable rear spring mounting brackets.
